(19) United States
(12) Patent Application Publication
(10) Pub. No.: US 2009/0008528 A1
(43) Pub. Date: Jan. 8, 2009

(54) VERTICAL-TYPE FINISHING MACHINE

(75) Inventor: Yuk-Ming Chung, Hong Kong (HK)

Correspondence Address: SHERIDAN ROSS PC, 1560 BROADWAY, SUITE 1200, DENVER, CO, 80202, US

(73) Assignee: L.K. MACHINERY CORP., Taichung County (TW)

(21) Appl. No.: 12/167,694

(22) Filed: Jul. 3, 2008

(30) Foreign Application Priority Data
Jul. 4, 2007 (TW) 096210889

(51) Int. Cl. F16M 1/00

(52) U.S. Cl. 248/672; 83/859

(57) ABSTRACT

A vertical-type finishing machine includes: a single piece of a supporting body including a horizontally extending bed and a vertically extending post upright from the horizontally extending bed; a tool carrier mounted movably on the vertically extending post; and a worktable mounted movably on the horizontally extending bed. The post has a straight vertical segment disposed above the bed, and a buttress segment flaring and extending downwardly from the straight vertical segment to the bed.

### CROSS-REFERENCE TO RELATED APPLICATION

This application claims priority of Taiwanese Application No. 096210889, filed on Jul. 4, 2007.

### BACKGROUND OF THE INVENTION

1. Field of the Invention

This invention relates to a vertical-type finishing machine, more particularly to a vertical-type finishing machine including a single piece of a supporting body that includes a horizontally extending bed and a vertically extending post upright from the horizontally extending bed.

2. Description of the Related Art

FIG. 1 illustrates a conventional vertical-type finishing machine 1 that includes a bed 11, a post 12 upright from the bed 11, a worktable 13 mounted movably on the bed 11, and a tool carrier 14 mounted on the post 12. The post 12 has a bottom mounting plate secured to the bed 11 through fasteners 15.

The conventional vertical-type finishing machine 1 is disadvantageous in that a bending moment resulting from the weight of the tool carrier 14 and from vibrations or the counter force acting on the tool carrier 14 during cutting or drilling operations generates bending, shear and axial stresses in the fasteners 15, which tends to result in metal failure or creeping for the fasteners 15 and shorter service life of the fasteners 15.

### SUMMARY OF THE INVENTION

Therefore, an object of the present invention is to provide a vertical-type finishing machine that can overcome the aforesaid drawback associated with the prior art.

According to this invention, there is provided a vertical-type finishing machine that comprises: a single piece of a supporting body including a horizontally extending bed and a vertically extending post upright from the horizontally extending bed; a tool carrier mounted movably on the vertically extending post; and a worktable mounted movably on the horizontally extending bed.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a perspective view of a conventional vertical-type finishing machine; and

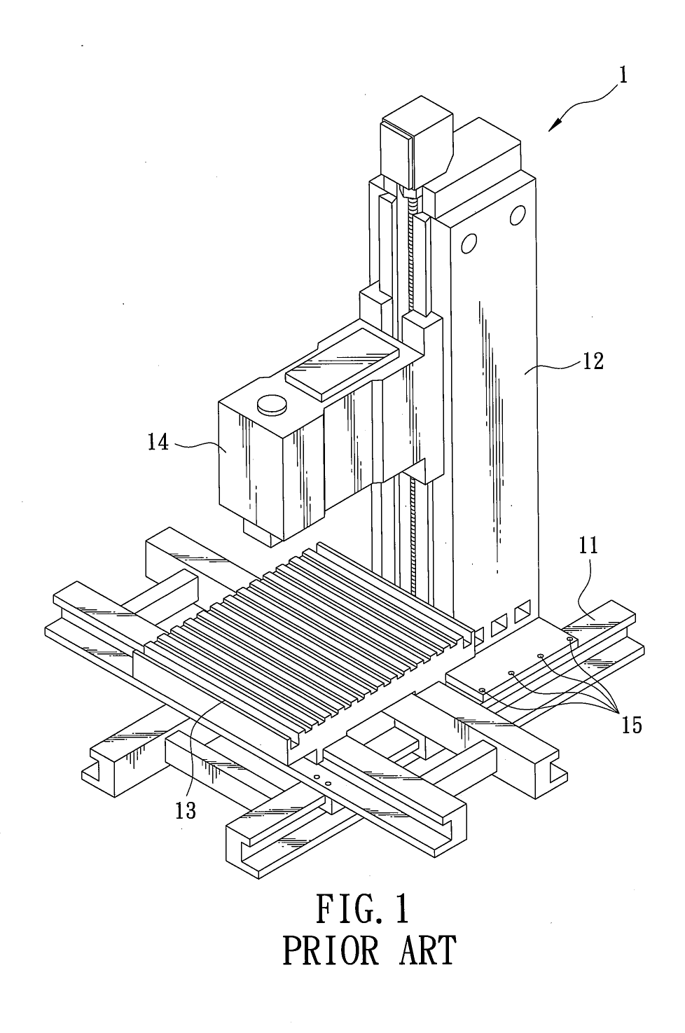

FIG. 2 is a perspective view of the preferred embodiment of a vertical-type finishing machine according to this invention.

### DETAILED DESCRIPTION OF THE PREFERRED EMBODIMENT

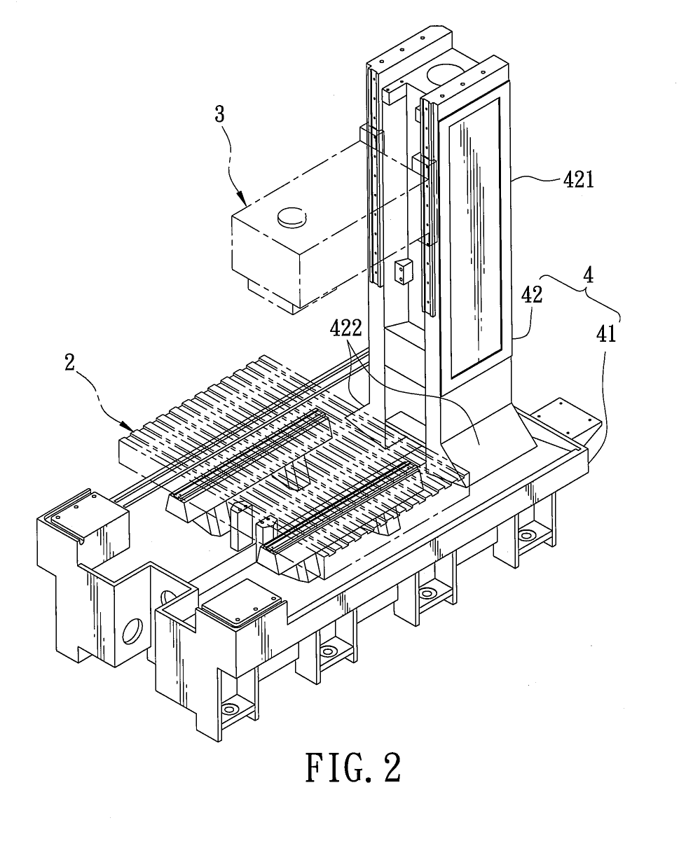

FIG. 2 illustrates the preferred embodiment of a vertical-type finishing machine according to this invention. The vertical-type finishing machine includes: a single piece of a supporting body 4 including a horizontally extending bed 41 and a vertically extending post 42 upright from the horizontally extending bed 41; a tool carrier 3 mounted movably on the vertically extending post 42; and a worktable 2 mounted movably on the horizontally extending bed 41.

In this embodiment, the post 42 has a straight vertical segment 421 disposed above the bed 41, and a buttress segment 422 flaring, i.e., enlarged in cross-section, and extending downwardly from the vertical segment 421 to the bed 41. Note that the bed 41 and the straight vertical segment 421 and the buttress segment 422 of the post 42 constitute the single piece of the supporting body 4.

By virtue of the single piece of the supporting body 4 of the vertical-type finishing machine of this invention, the aforesaid fasteners 15 used in the conventional vertical-type finishing machine 1 can be dispensed with and the aforesaid drawback associated with the use of the fasteners 15 can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed:

1. A vertical-type finishing machine comprising:
a single piece of a supporting body including a horizontally extending bed and a vertically extending post upright from said horizontally extending bed;
a tool carrier mounted movably on said vertically extending post; and
a worktable mounted movably on said horizontally extending bed.

2. The vertical-type finishing machine of claim 1, wherein said vertically extending post has a straight vertical segment disposed above said horizontally extending bed, and a buttress segment flaring and extending downwardly from said straight vertical segment to said horizontally extending bed.
